(19) United States
(12) Patent Application Publication
(10) Pub. No.: US 2021/0334740 A1
(43) Pub. Date: Oct. 28, 2021

(54) CONTEXTUAL MODELING AND PROACTIVE INVENTORY MANAGEMENT SYSTEM AND METHOD FOR INDUSTRIAL PLANTS

(71) Applicant: Buckman Laboratories International, Inc., Memphis, TN (US)

(72) Inventors: Narasimha M. Rao, Collierville, TN (US); Arun Kumar Raju Ganesan, Germantown, TN (US)

(21) Appl. No.: 17/243,438

(22) Filed: Apr. 28, 2021

Related U.S. Application Data
(60) Provisional application No. 63/016,936, filed on Apr. 28, 2020.

(51) Int. Cl. G06Q 10/08; G06Q 10/06; G06Q 10/04; G06F 16/22; G06F 16/28

(52) U.S. Cl. CPC G06Q 10/087; G06Q 10/06315; G06Q 10/04; G06F 3/0481; G06F 16/2246; G06F 16/288; G06Q 10/06312

(57) ABSTRACT

Systems and methods are disclosed herein for optimizing the supply of products to industrial plants. Each of multiple data streams in a plant are mapped to a common hierarchical data structure, wherein the data streams correspond to respective values or states associated with process elements. The mapped data streams define hierarchical process relationships between subsets of the respective process elements. One or more of the process elements are determined as correlating to consumption for each of the supplied products. Real-time data are collected to populate at least one level of the hierarchical data structure for one or more of the data streams, and data is inferred to virtually populate the at least one level of the hierarchical data structure for at least one other data stream, based on the collected real-time data for data streams having defined derivative relationships therewith. An output corresponding to a replenishment schedule is dynamically produced for each supplied product.

### CROSS-REFERENCES TO RELATED APPLICATIONS

This application claims benefit of U.S. Provisional Patent Application No. 63/016,936, filed Apr. 28, 2020, and which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present invention relates generally to inventory management for industrial plants and equivalent facilities. More particularly, an embodiment of an invention as disclosed herein relates to a cloud-based solution for suppliers of packaged and bulk products to industrial plants for use in their respective processes, implementing contextual modeling and data analysis to proactively predict, and automatically respond to, inventory replenishment needs.

One of skill in the art may appreciate the desirability for chemical product suppliers to be able to remotely view inventory, ascertain usage rates as they change in real time, understand relationships between process parameters that the chemistry is treating, and further to manage the replenishment of multiple chemicals at various customers with sufficient lead time. It is further desirable to manage all the above services in the background, i.e., remotely with respect to a given customer.

Unfortunately, the conventional distribution systems and methods include numerous obstacles to the above-referenced objectives. Various types of containers are used to supply chemical products to each customer, and may be scattered hundreds of feet apart from other containers at a facility that need to be monitored. To the extent that process data may be captured internally by a respective customer, such data is not necessarily shared or otherwise made available for the supplier. Monthly usage data is typically totalized and used for internal consignment reporting.

Real-time usage monitoring is particularly important, in that chemical consumption and customer process variables can change sporadically, causing chemistry demand and lead times to fluctuate in a manner that is out of control of the supplier. However, installation costs and the associated time requirement for installation units can be prohibitively expensive.

Conventional tools for monitoring product levels at individual stages in an industrial process include level sensors and dedicated viewing consoles, for example to monitor real-time levels of product and provide basic calculations (without context) for displaying an amount of usage per day, and/or a number of days remaining in the supply. Such devices are typically standalone in nature, and lack any discernable relationship to internal supply chains or customer process variability. The respective outputs may require a hard-wired connection to a local controller for conversion/ calibration and subsequent transmittal to a destination, which as previously mentioned may not be available to a remote supplier. Cellular SIM cards may be implemented in some cases, but cellular data coverage across industrial plants can be inconsistent, at best.

A further problem arising from conventional analysis of data from industrial plants is that, even though massive amounts of data may be collected and even meaningful for the user who collected the data, the usefulness of data very quickly dissipates when one moves further away from the point of data collection. The remote user looking at the data does not understand the context of the data without further explanation. Neither the data collector nor the remote user in conventional data analysis will be aware of how one piece of data connects to another piece of data elsewhere in the plant. Likewise, the data without a contextual framework cannot be easily compared to other data points outside of the respective plant. Some of the advanced calculations that can use the data to generate unique insights are impossible because all of the data pieces do not share the same framework and context. In short, the real value of data collected today is far short of what it could be if it had the right context and framework.

### BRIEF SUMMARY

Generally stated, systems and methods as disclosed herein may be implemented to monitor inventory, such as for example packaged and bulk chemical products supplied to industrial plants, using advanced wireless technology that enables real-time decision support for users such as sales associates or customers from data calculations working in the background. Various embodiments may enable decision support regarding real-time usage, optimized order fulfillment recommendations, process variability integration, alerts and alarms, full integration into an internal pricing database, and supply chain order tracking, with all streams seamlessly connected in context, working together to provide insights to financial implications, process performance, and other key performance measures for each product being consumed at a location.

A system and method as disclosed herein may be configured to send any associated wireless sensor data for remote/cloud server-based storage and processing (e.g., via Microsoft Azure) to monitor, manage, alert, and compare process variability with respect to chemical consumption. Level sensor data may be captured of various types, including ultrasonic and differential pressure data, and may encompass manually entered information via a user interface. A communications network including end components such as for example a remote wireless modem is used for point-to-point data transmittal. A mobile and/or web application may be implemented at computing nodes for user interface (data entry, display, alerts).

An embodiment of a system and method as disclosed herein may further or accordingly enable users to collect and organize data about industrial customers in a structured, visual way. The invention allows allocation of unambiguous context to every piece of data, potentially establishing relationships with every other piece of data in the plant. The value of each piece of data is enhanced significantly as a result of these contextual connections, enabling the development of insights that are otherwise impossible using existing relational data bases and equivalent means of capturing data. Such embodiments further enable the host user to compare one industrial plant to any number of other like plants to develop insights in an unconventional manner.

In a particular embodiment of a computer-implemented method performed by a supplier of one or more products to a plurality of industrial plants, the following steps may be performed for each of the plurality of industrial plants. Each of a plurality of data streams in an industrial plant are mapped to a common hierarchical data structure, wherein the data streams correspond to respective values or states generated in association with each of one or more process elements, and wherein the mapped data streams define hierarchical process relationships between subsets of the respective process elements. One or more of the plurality of process elements are determined as correlating to consumption for each of the one or more products supplied to the industrial plant. Real-time data are collected to populate at least one level of the hierarchical data structure for one or more of the plurality of data streams, and additional data is inferred to virtually populate the at least one level of the hierarchical data structure for another one or more of the plurality of data streams, based on the collected real-time data for one or more data streams having a defined derivative relationship therewith. An output is dynamically produced corresponding to a replenishment schedule for the each of the one or more products supplied to the industrial plant based on the collected real-time data and the inferred data corresponding to real-time values or states for each respectively correlated process element.

In one exemplary aspect of the above-referenced embodiment, the mapped data streams defining hierarchical process relationships between subsets of the respective one or more process elements are dynamically generated based on input from a graphical user interface generated on a display unit.

For example, the graphical user interface may comprise visual elements corresponding to respective unit operations, assets, or process streams, and tools enabling the selective arranging of the visual elements corresponding to their respective interactions there between, wherein one or more of the defined hierarchical process relationships are determined based on a spatial and/or temporal process flow between selectively arranged visual elements.

As a further example, the graphical user interface may enable data entry for one or more states and/or values associated with one or more of the selectively arranged visual elements, and one or more of the unit operations, asserts, or process streams for which data entry is available, and/or data limits or ranges for one or more of the unit operations, asserts, or process streams for which data entry is available, are dynamically determined based on the established relationships between the corresponding visual elements and others of the selectively arranged visual elements.

In another exemplary aspect of the above-referenced embodiment, as may likewise be combinable with other of the above-referenced aspects, the dynamically produced output may be an alert generated to a user when a determined level of at least one of the one or more products is less than a specified threshold level.

In another exemplary aspect of the above-referenced embodiment, as may likewise be combinable with other of the above-referenced aspects, a future level may be predicted for at least one of the one or more products as being less than a specified threshold level, wherein the predicted future level is based on the collected real-time data for at least one data stream, and at least one other data stream having a defined hierarchical process relationship therewith and further corresponding to a process element correlated with the at least one of the one or more products.

The dynamically produced output may accordingly be an alert generated to a user when the predicted future level of the at least one of the one or more products is less than the specified threshold level

In another exemplary aspect of the above-referenced embodiment, as may likewise be combinable with other of the above-referenced aspects, the dynamically produced output may be associated with an automated replenishment order for at least one of the one or more products.

For example, a replenishment schedule may be dynamically recalculated for the at least one of the one or more products with respect to each of the plurality of industrial plants.

In another exemplary aspect of the above-referenced embodiment, as may likewise be combinable with other of the above-referenced aspects, future ambient temperature data may be determined for at least a portion of the industrial plant. Accordingly, the data may be inferred to virtually populate the at least one level of the hierarchical data structure for the another one or more of the plurality of data streams, based on the collected real-time data for one or more data streams having a defined derivative relationship therewith, and further based on the determined future ambient temperature data.

In another exemplary aspect of the above-referenced embodiment, as may likewise be combinable with other of the above-referenced aspects, the respective process elements may comprise one or more of: a unit operation; an asset; and a process stream.

In another embodiment, a system may be provided with at least one server in functional association with a data storage network and a communications network. The server is configured for bilateral data communication with each of a plurality of industrial plants via the communications network, and with one or more user computing devices configured to generate a user interface on a display unit thereof. The server is further configured, for each respective one of the plurality of industrial plants, to implement a method in accordance with the above-referenced embodiment and associated exemplary aspects.

In another embodiment, a system for optimizing the supply of one or more chemical products to a plurality of industrial plants may be characterized as follows: means for directly monitoring real-time values or states for one or more of a plurality of process elements correlating to consumption for each of the one or more products supplied to the industrial plant; means for generating data corresponding to virtual values or states for each of any remaining one or more process elements, based on established hierarchical data relationships between certain ones of the plurality of process elements; and means for dynamically producing an output corresponding to a replenishment schedule for the each of the one or more products supplied to the industrial plant, based on the directly monitored data and the generated data.

Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is block diagram representing an embodiment of a system as disclosed herein.

FIG. 2 is a block diagram representing an exemplary data flow from sensors to a mobile or web application according to a system and method of the present disclosure.

FIG. 3 is a graphical representation of a bulk delivery determination according to a system and method of the present disclosure.

FIG. 4 is a graphical representation of a user interface with associated tools for generating a process configuration and establishing relationships between selected items according to a system and method of the present disclosure.

FIG. 5 is a flowchart representing an exemplary method of operation according to an embodiment of the present disclosure.

### DETAILED DESCRIPTION

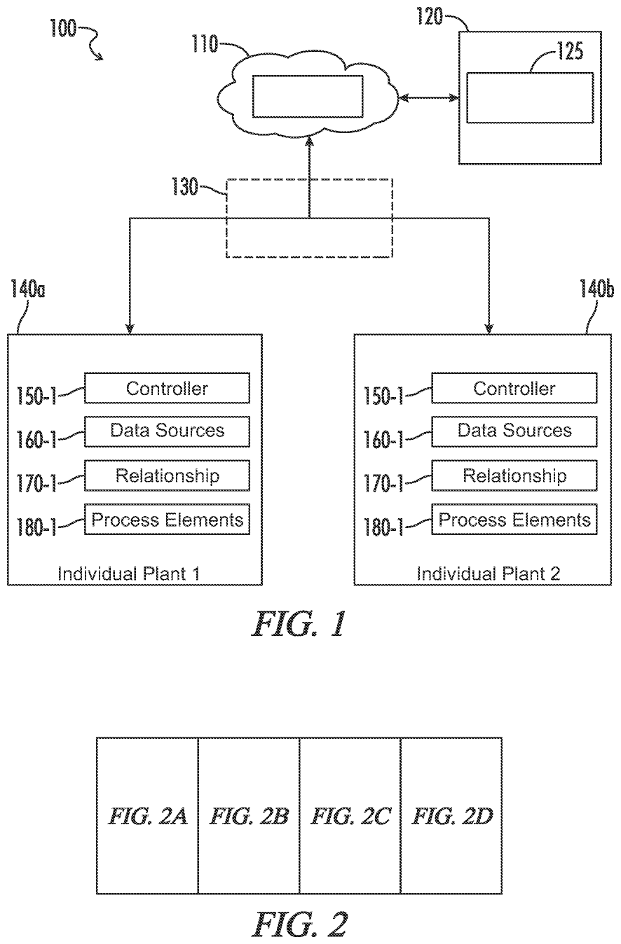

Referring generally to FIGS. 1-5, various exemplary embodiments of an invention may now be described in detail. Where the various figures may describe embodiments sharing various common elements and features with other embodiments, similar elements and features are given the same reference numerals and redundant description thereof may be omitted below.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Referring first to FIG. 1, an embodiment of a cloud-based inventory control system 100 as disclosed herein may be provided with respect to each of one or more industrial plants 140 having at least products, such as for example chemical products, supplied by a hosted system. The term “industrial plant” as used herein may generally connote a facility for production of goods, independently or as part of a group of such facilities, and may for example involve an industrial process and chemical business, a manufacturing industry, food and beverage industry, agricultural industry, swimming pool industry, home automation industry, leather treatment industry, paper making process, and the like.

The illustrated system 100 according to FIG. 1 refers to a cloud-based server 110 further functionally linked to at least one user computing device 120 having a display unit 125 for implementing a graphical user interface as further described herein. In alternative embodiments, it may be that the system is locally implemented with respect to an industrial plant 140, wherein the cloud-based aspects are omitted. The user computing device 120 may in further alternative embodiments be functionally linked to the industrial plants 140 via the communications network 130 and configured to act as the server 110 for the purpose of data collection and processing as disclosed herein.

Each industrial plant 140 as shown in FIG. 1 as including a local controller 150 which may be functionally linked to the server 110 via the communications network 130. The controller 150 may be configured for example to direct the collection and transmittal of data from the industrial plant 140 to the cloud server 110, and further to direct output signals from the server to other process controllers at the plant level or more directly to process actuators in the form of control signals to implement automated interventions. In some embodiments the controller 150 may be omitted, where for example data collection tools are distributed to directly transmit data streams via the communications network 130, and the user computing device 120 is implemented to receive the output signals from the server 110, etc. In some embodiments, the controller 150 may be comprised of at least part of an industrial plant's resident control system.

Various process elements 180 as referenced in FIG. 1 with respect to individual plants 140 may be determined as correlating to the consumption of one or more products, e.g., package or bulk chemical products, supplied by the system host. Real-time states or values for a first group of the process elements may be directly sensed or measured by the system host, or at least the system 100 may be configured to collect or otherwise obtain such data, whereas real-time states or values for a second group of the process elements may be effectively unavailable for direct sensing, measuring, or collection by the system 100.

A system “host” as referred to herein may generally be independent of a given industrial plant 140, but this aspect is not necessary within the scope of the present disclosure. The term host may encompass a product supplier entity including or otherwise directing the performance of a product dispatch site and a product distribution center (which may be at the same location as the dispatch site). The host may directly supply chemical products to each of a plurality of industrial plants (e.g., 140a and 140b), or may direct one or more third party chemical suppliers to supply chemical products to some or all of the industrial plants. In either case, the system host may be directly associated with an embodiment of the server system 100 and capable of directly or indirectly implementing contextual data analysis and/or automated product replenishment as disclosed herein for each of a group of industrial plants.

A data collection stage 160 may be provided into the system 100 to provide real time sensing or measurements for at least the first group of process elements 180 referred to above. Exemplary process elements may include unit operations, simple assets, and/or process streams associated with a given industrial plant 140. The term “unit operations” as used herein may generally relate to, e.g., cooling towers, heat exchangers, boilers, brown stock washers, and the like, merely for illustrative purposes and without limiting the scope of the term beyond what would otherwise be readily understood by one of skill in the art. The term “assets” as used herein may generally relate to, e.g., chemical tanks, storage facilities, and the like, again merely for illustrative purposes and without limiting the scope of the term beyond what would otherwise be readily understood by one of skill in the art. The term “process streams” as used herein may generally relate to, e.g., interconnecting channels of water, energy, material (e.g., fiber), and the like between other elements, yet again merely for illustrative purposes and without limiting the scope of the term beyond what would otherwise be readily understood by one of skill in the art. It should further be understood that examples used herein for one of the above terms (e.g., unit operations) may also or otherwise be implemented as another of the above terms (e.g., assets), depending for example on the manner of implementation or simple user preference.

One or more online sensors may for example be configured to provide substantially continuous and wireless signals representative of values or states of certain process elements. The term “sensors” may include, without limitation, physical level sensors, relays, and equivalent monitoring devices as may be provided to directly measure values or variables for the process elements 180, or to measure appropriate derivative values from which the process elements 180 may be measured or calculated, as well as user interface components for data entry. The term “online” as used herein may generally refer to the use of a device, sensor, or corresponding elements proximally located to a container, machine or associated process elements, and generating output signals in real time corresponding to the desired process elements, as distinguished from manual or automated sample collection and “offline” analysis in a laboratory or through visual observation by one or more operators.

Individual data collectors 150 may be implemented for respective data streams, or in some embodiments one or more individual data collectors may provide respective output signals that are implemented for the calculation of values or states for multiple data streams. Individual data collectors may be separately mounted and configured, or the system 100 may provide a modular housing which includes, e.g., a plurality of sensors or sensing elements. Sensors or sensor elements may be mounted permanently or portably in a particular location respective to the production stage, or may be dynamically adjustable in position so as to collect data from a plurality of locations during operation.

One or more additional data collectors 160 may provide substantially continuous measurements with respect to various controlled process elements 180. The term “continuous” as used herein, at least with respect to the disclosed sensor outputs, does not require an explicit degree of continuity, but rather may generally describe a series of measurements corresponding to physical and technological capabilities of the sensors, the physical and technological capabilities of the transmission media, the physical and technological capabilities of any intervening local controller 150 and/or interface configured to receive the sensor output signals, etc. For example, measurements may be taken and provided periodically and at a rate slower than the maximum possible rate based on the relevant hardware components, or based on a communications network 130 configuration which smooths out input values over time, and still be considered “continuous.”

The data collection stage 160 of the exemplary system 100 as disclosed herein may comprise more than just streaming sensors, and may further include manual data streams such as for example provided by users in a spreadsheet or the like, customer relationship management (CRM) data streams, and external data streams such as for example digital control system (DCS) information from the industrial plants, third party weather information, and the like.

Each of one or more fixed or mobile user interfaces 125 may be provided and configured to display process information and/or to enable user input regarding aspects of the system and method as disclosed herein. For example, a user may be able to selectively monitor process elements 180 in real-time, and also selectively modify parameters or system elements which for example represent a customer's process configuration and thereby establish hierarchical data relationships 170 between the process elements 180. The term “user interface” as used herein may unless otherwise stated include any input-output module with respect to the hosted data server including but not limited to: a stationary operator panel with keyed data entry, touch screen, buttons, dials or the like; web portals, such as individual web pages or those collectively defining a hosted website; mobile device applications, and the like. Accordingly, one example of the user interface may be as generated remotely on a user computing device 120 and communicatively linked to the remote server 110.

Alternatively, an example of the user interface 125 may within the scope of the present disclosure be generated on a stationary display unit in an operator control panel (not shown) associated with the production stage of an industrial plant 140.

The data from the data collection stage 160, for example outputs from level sensors and in some cases the input data from customer users, corresponding to one or more process elements 180 may be provided to the server 110 via a communications network 130 via one or more network interface devices such as for example a wireless modem. In some embodiments, the local controller 150 may be implemented and configured to directly receive the aforementioned signals and perform specified data processing and control functions, while separately corresponding with the remote server 110 (cloud-based computing network) via the communications network 130 including a communications device. Each level sensor data stream, for example, may be connected by a hard wired connection or a wireless link to the local controller wherein identifying information associated with each data stream (e.g., a particular bulk container or product) may be further received by the remote server 110.

In an embodiment (not shown), a conversion stage may be added for the purpose of converting raw signals from one or more of the online data collectors 160 to a signal compatible with data transmission or data processing protocols of the communications network 130 and/or cloud server-based storage and applications. A conversion stage may relate not only to input requirements but also may further be provided for data security between one or more data sources 160 and the server 110, or between local computing devices such as a controller 150 and the server 110.

The term “communications network” 150 as used herein with respect to data communication between two or more system components or otherwise between communications network interfaces associated with two or more system components may refer to any one of, or a combination of any two or more of, telecommunications networks (whether wired, wireless, cellular or the like), a global network such as the Internet, local networks, network links, Internet Service Providers (ISP's), and intermediate communication interfaces. Any one or more recognized interface standards may be implemented therewith, including but not limited to Bluetooth, RF, Ethernet, and the like.

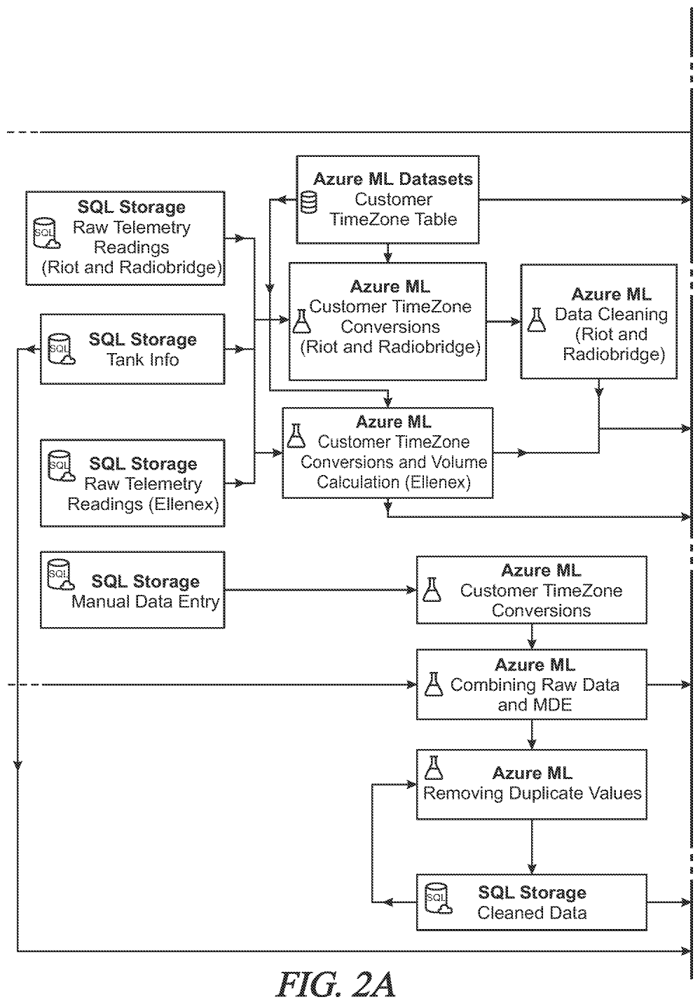

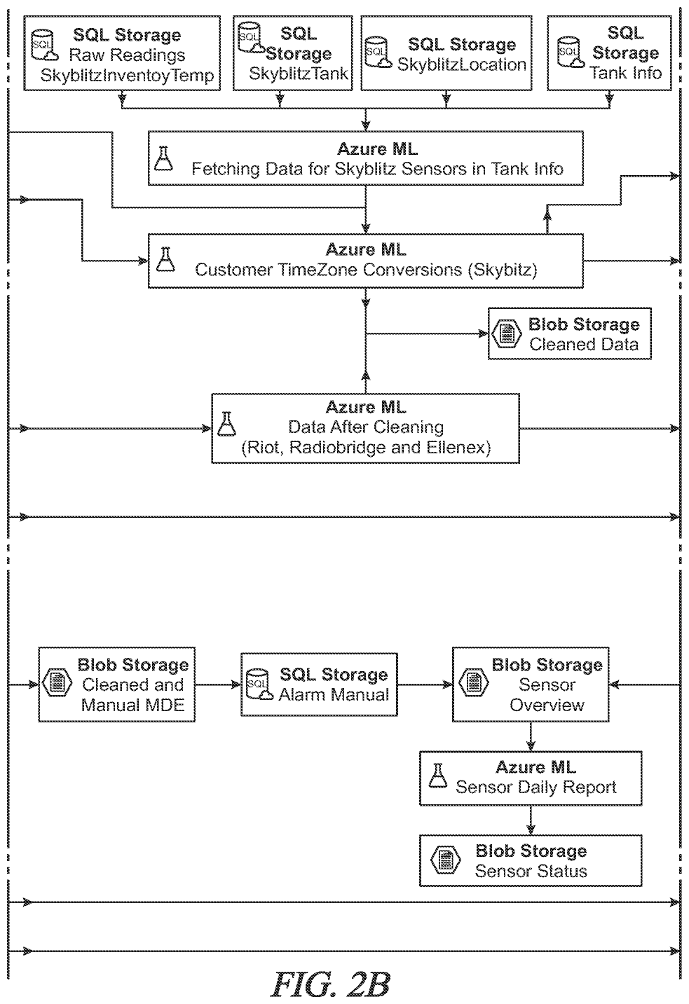

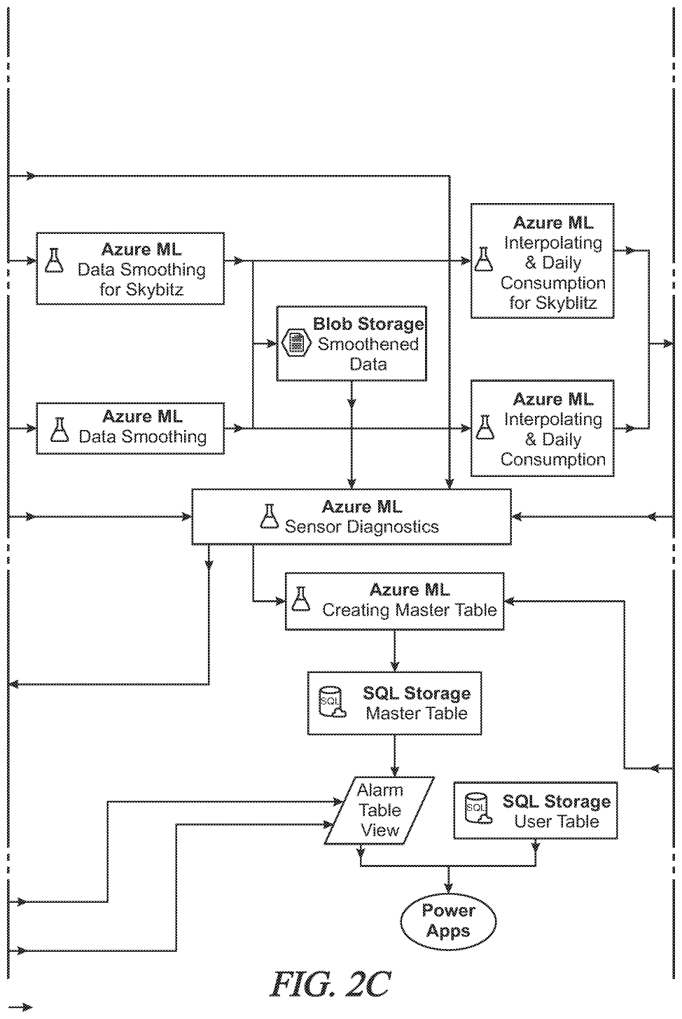

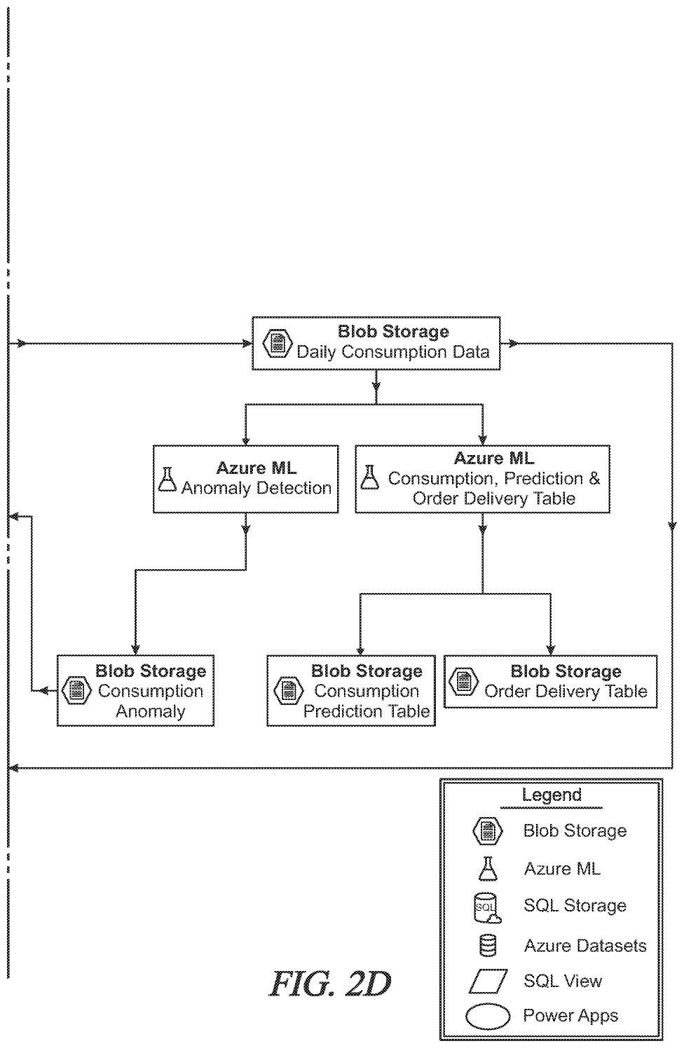

An exemplary data flow from data collectors 160 to mobile or web application as described herein may be as illustrated in FIG. 2.

In an embodiment, the remote server 110 may further include or be communicatively linked to a proprietary cloud-based data storage. The data storage may for example be configured to obtain, process and aggregate/store data for the purpose of developing correlations over time, improving upon existing linear regressions or other relevant iterative algorithms, etc.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Various embodiments of a method as disclosed herein may be implemented by the above-referenced systems 100 to automatically establish and leverage relationships 170 between process elements 180 such as customer processes, process equipment, treatment parameters and dosage rates, wherein a system as discussed above is enabled to, e.g., predict treatment success based on relationships in the system database.

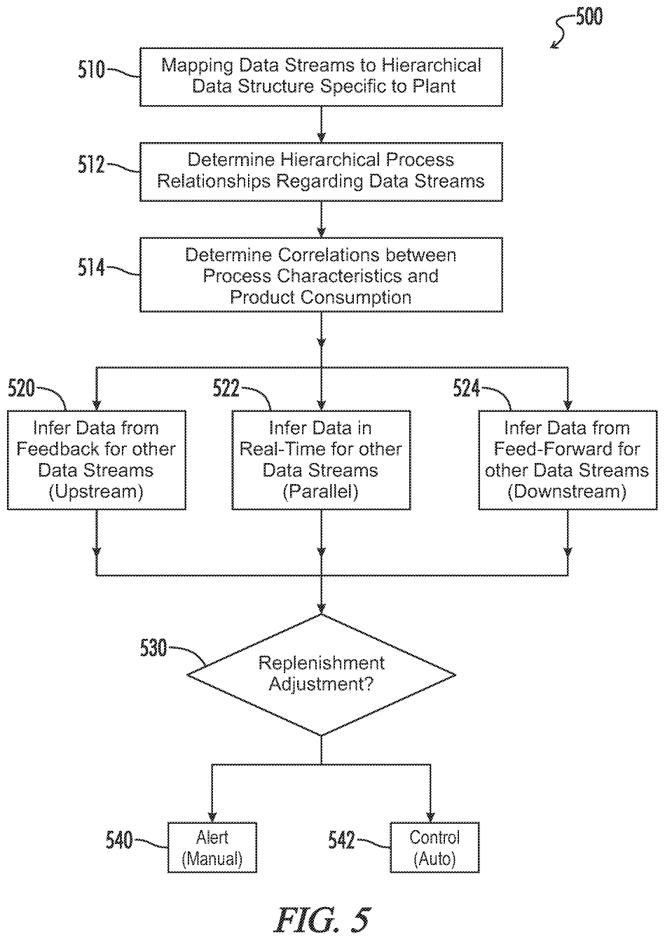

One particular embodiment of a method 500 may be further described with reference to FIG. 5. Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

For a given industrial plant 140a, the method 500 of the present embodiment begins by mapping each of a plurality of data streams in an industrial plant to a common hierarchical data structure, wherein the data streams correspond to respective values or states generated in association with each of one or more process elements 180 (e.g., unit operations, assets, process streams) in the industrial plant 140a (step 510). The mapped data streams may further define hierarchical process relationships between subsets of the respective process elements (step 512).

Generally stated, the method 500 implements a structured approach to collecting data in an industrial plant 140 that gives the same framework and structure to all data at the site in order to definitely establish their relationship 170 relative to each other. In one embodiment, the structure may be defined in layers as including: {customer/entity}; {location}; {process (and sub-process, sub-sub-process, etc.)}; asset (and sub-asset, sub-sub-asset, etc.)}; {device/data source}.

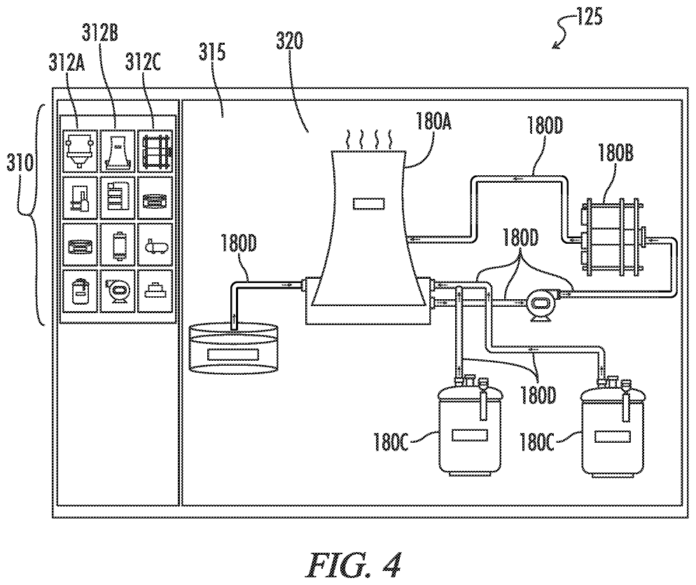

In one example, the establishment of such hierarchical process relationships 170 and associated contextual links in the context of a core data structure can be provided dynamically using user interface tools as illustrated in FIG. 4. A user may be provided with graphical icons to create a process flow diagram associated with the industrial plant 140a, for example by ‘dragging and dropping’ icons from dedicated tiles on the left side of the screen into a primary window and then appropriately linking the represented process elements 180. The graphical icons can represent, e.g., unit operations (e.g., cooling towers, heat exchangers, boilers, Brown stock washers, etc.), process streams, or simple assets (e.g., chemical tanks, storage facilities, etc.). Every icon in the process flow diagram may also have selectable and specific data fields that describe the mechanical, operational, chemical (or other) parameters associated with that icon. Additional data inputs can be added by provisioning a streaming sensor or a manual data entry point to the icon. The data from these can be added to further enrich the data content associated with each icon. Lines, representing process streams, may further connect various icons, wherein the flow of water, energy, fiber or other components can be described in the graphical interface. The contextual view then can be used to carry out various advanced calculations to generate unique insights.

Such contextual links can enable the generation of data for a group of process elements 180 which otherwise lack direct real-time data sources, as further noted below. In addition, one of skill in the art may appreciate the potential use of flow sheet simulators to conduct a water, energy and material balance of an industrial system. When data from sensors or manual data is “provisioned” on an icon or a stream, that data can be used to predict problems long before they actually create harm. For example, if one associates a calcium sensor to a cooling water make-up stream, and if the calcium level were to suddenly increase, a steady state simulation in the cloud can detect that the system will foul in roughly twenty-four hours. This insight can be used to take proactive action to feed more chemistry or change the make-up water source, potentially avoiding substantial monetary impacts from lost heat exchange or downtime from having to clean the exchanger. This combination of steady-state simulation and real-time sensing may be a particularly advantageous result of such embodiments as disclosed herein.

In alternative embodiments of a method 500 as disclosed herein, or as a supplement to the aforementioned embodiment utilizing user interface tools, relationships 170 between process elements 180 may be determined using, e.g., supervised learning techniques or reference to linked databases or look-up tables. As one example, the system 100 may have determined that a particular type of customer process is being implemented, using a particular combination of chemical products, wherein one or more defined relationships 170 may be extracted and implemented accordingly to generate data for the second group of (i.e., not directly monitored) process elements 180, further in view of directly captured data for some or all of the first group of (i.e., directly monitored) process elements 180.

The method 500 determines one or more products being supplied for customer processes, wherein the system 100 is further configured to determine process elements 180 correlating to consumption of the one or more products (step 514). For example, it may be determined that for a first product X supplied by the host to an industrial plant 140a, consumption of the product may be determined by reference to measurements of one or more process elements 180, taken alone or as determined algorithmically from a combination thereof. Accordingly, data may be directly captured for at least some of the data streams, namely, as many of the various process elements 180 that correlate to the products' consumption and are further available to the host (step 516).

As previously noted, a second group of process elements 180 may remain which are not detected directly via the data collection stage 160. Accordingly, ‘virtual’ sensor values corresponding to these process elements 180 may be desirably generated based on relationships 170 which can be established or otherwise identified with one or more other process elements 180 or associated data streams.

Contextual links as provided herein may for example enable feedback data, from collected real-time data associated with a downstream operation, to data streams having a defined hierarchical (i.e., upstream) process relationship 170 therewith and otherwise lacking real-time data collection (step 520). Virtual data may accordingly be inferred for various ones of the second group of process elements 180 that are hierarchically disposed upstream from one or more of the first group of process elements.

Contextual links as provided herein may alternatively, or in addition, enable virtual data to be inferred for various ones of the second group of process elements 180 that are hierarchically disposed in parallel with one or more of the first group of process elements (step 522).

Contextual links as provided herein may alternatively, or still further in addition, enable “feed-forward” implementation of data, from collected real-time data associated with an upstream operation, with respect to data streams having a defined hierarchical (i.e., downstream) process relationship 170 therewith and otherwise lacking real-time data collection (step 524). Virtual data may accordingly be inferred for various ones of the second group of process elements 180 that are hierarchically disposed downstream from one or more of the first group of process elements.

In some embodiments, the server 110 may further obtain future ambient temperature data for at least a portion of the industrial plant 140, wherein the future outcome for a downstream operation may further be predicted based on the collected real-time data for at least one data stream, at least one other data stream having a defined hierarchical process relationship 170 therewith, and the determined future ambient temperature data. For example, knowing that a certain condition is present at a downstream operation may serve as one indication regarding the future condition at an upstream operation, based on the hierarchical data relationships 170 there between, but the future condition at the upstream condition is also known to be impacted by changes in the local temperature or other measurable and predictably forecast ambient conditions. In that case, the server can improve upon outcome projections by implementing such forecast changes. In some embodiments, the server may only implement forecast changes above a certain threshold (e.g., heat above a threshold temperature, or below a threshold temperature, or changes in heat above a threshold delta value, etc.), or may further determine and weigh a reliability of the forecast.

Generally stated, contextual data as enabled by a system and method as disclosed herein provides insights that are otherwise unavailable. For example, a chemical tank may contain a corrosion inhibitor, fitted with a level sensor and a pump provisioned to the tank, and feeding into a stream. A corrosion sensor is provisioned to the stream. A system as disclosed herein may be configured to monitor the pump “on time” data, the level sensor data, and the corrosion rate data, wherein a number of unambiguous determinations may be subsequently made, e.g., whether the pump is air-licked, whether the corrosion sensor is working, whether the tank has run out of the corrosion inhibitor, etc. The system can further remotely calibrate the pumping rate using level sensor data, etc.

In an embodiment as illustrated in FIG. 5, the method 500 may further include dynamically producing an output with respect to a replenishment schedule for one or more of the supplied products for a given industrial plant, as needed (step 530).

For example, if the system determines that the level for at least one product is approaching a threshold level, or predicts that the level will more rapidly approach the threshold level further based on changing consumption rates or detected derivative impacts based on the established relationships with other process elements, the method 500 may include generating an alert or even an audio/visual alarm via a user interface associated with an operator of the customer process or a host user on the back end (step 540). The alert may for example prompt the user to manually approve or otherwise submit a replenishment request or command in accordance with standard processes for that supplier/customer arrangement.

Alternatively, or in addition, the method 500 may include generating the output to an automated ordering module, wherein an intervention such as the replenishment itself may be provided without requiring manual approval or preliminary notification (step 542).

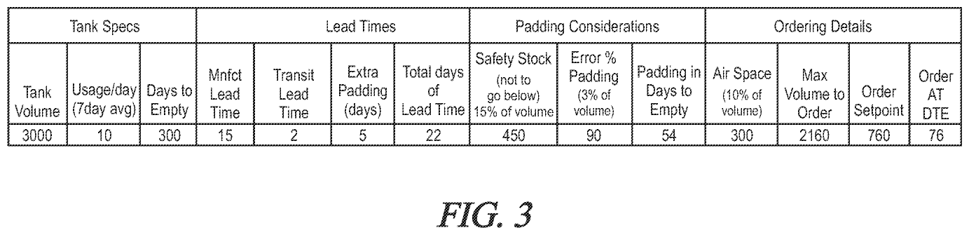

Referring to FIG. 3, the illustrated fields are associated with an exemplary determination of optimum bulk delivery for tanks according to the present application. Beginning with parameters such as a tank volume (3000) and a usage rate per day over a seven day average (10), a number of days to empty the tank is calculated at 300. Various lead times for the associated product are then provided with respect to a manufacture lead time (15 days), a transit lead time (2 days) and a margin of safety (5 days), wherein a total of 22 days of lead time is provided. Various considerations regarding the margin of safety (“padding”) include a safety stock of 450 (i.e., 15% of the total volume of the tank) plus a further margin of safety of 90 (i.e., 3% of the total volume of the tank), which yields a 54-day margin of safety between a replenishment level and the likely point at which the tank will be empty. The ordering details are determined as including a safety “overfill” level of 300 (i.e., 10% air space relative to the total volume of the tank), and a maximum volume to order of 2160 (based on the total volume of the tank, less the safety overfill value and the padding considerations). An order setpoint (threshold value) can be set at 760, based on the total days of lead time and the padding considerations, wherein an order would be placed with 76 projected days ahead of the tank being emptied at the normal usage rate.

In an embodiment, an automated ordering process may be initiated when the order point is reached, utilizing predictive analytics and contextual data flow as previously described herein. The system may be configured to observe other potential orders, wherein further optimization and consolidation of orders may be carried out, for example with respect to other industrial plants receiving the same product being ordered, and/or with respect to the same industrial plant receiving other products for which transit costs can be optimized by delivering in tandem. As previously noted, upon automatically determining that replenishment of one or more products is desired based on the system algorithms, a notification may be generated to a customer user for authorization and optimal supplementing of the order or relevant order information. In a preferred embodiment, the process is simplified wherein a “one click” approval of the order is enabled via the user interface. If a purchase order is required, the system may further generate or otherwise deliver an automated standard proposal to the customer. During each phase of the remainder of the order process- i.e., processing, manufacture, transit- a dashboard associated with the customer interface may be auto populated to transparently indicate the order status.

In an embodiment, users can benchmark the consumption impacts of process elements such as for example a unit operation at one industrial plant 140a against at least one other industrial plant 140b which has similar mechanical-operational-chemical attributes. This type of benchmarking allows one to very quickly assess the relative inventory levels and needs, and further take replenishment action as needed.

As one example, a common hierarchical data structure may be provided for each of the industrial plants 140a, 140b, wherein the server 110 may be configured to compare mapped data streams defining hierarchical process relationships 170 in the first industrial plant 140a with mapped data streams defining hierarchical process relationships 170 in the second industrial plant 140b. The server 110 may further generate one or more process benchmarks, based at least in part on collected real-time data from certain data streams associated with each of the industrial plants. The server 100 may still further ascertain that a predicted future inventory level corresponds to an issue requiring product replenishment by comparing the predicted future inventory level to one or more of the generated process benchmarks.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A computer-implemented method for optimizing the supply of one or more products to a plurality of industrial plants, the method comprising, for each of the plurality of industrial plants:
mapping each of a plurality of data streams in an industrial plant to a common hierarchical data structure, wherein the data streams correspond to respective values or states generated in association with each of one or more process elements, and wherein the mapped data streams define hierarchical process relationships between subsets of the respective process elements;
determining one or more of the plurality of process elements as correlating to consumption for each of the one or more products supplied to the industrial plant;
collecting real-time data to populate at least one level of the hierarchical data structure for one or more of the plurality of data streams;
inferring data to virtually populate the at least one level of the hierarchical data structure for another one or more of the plurality of data streams, based on the collected real-time data for one or more data streams having a defined derivative relationship therewith; and
dynamically producing an output corresponding to a replenishment schedule for the each of the one or more products supplied to the industrial plant based on the collected real-time data and the inferred data corresponding to real-time values or states for each respectively correlated process element.

2. The computer-implemented method of claim 1, wherein:
the mapped data streams defining hierarchical process relationships between subsets of the respective one or more process elements are dynamically generated based on input from a graphical user interface generated on a display unit.

3. The computer-implemented method of claim 2, wherein:
the graphical user interface comprises visual elements corresponding to respective process elements, and tools enabling the selective arranging of the visual elements corresponding to their respective interactions there between, and
one or more of the defined hierarchical process relationships are determined based on a spatial and/or temporal process flow between selectively arranged visual elements.

4. The computer-implemented method of claim 3, wherein:
the graphical user interface further enables data entry for one or more states and/or values associated with one or more of the selectively arranged visual elements, and
one or more of the process elements for which data entry is available, and/or data limits or ranges for one or more of the process elements for which data entry is available, are dynamically determined based on the established relationships between the corresponding visual elements and others of the selectively arranged visual elements.

5. The computer-implemented method of claim 1, wherein:
the dynamically produced output is an alert generated to a user when a determined level of at least one of the one or more products is less than a specified threshold level.

6. The computer-implemented method of claim 1, further comprising:
predicting a future level for at least one of the one or more products as being less than a specified threshold level, wherein the predicted future level is based on the collected real-time data for at least one data stream, and at least one other data stream having a defined hierarchical process relationship therewith and further corresponding to a process element correlated with the at least one of the one or more products; and
the dynamically produced output is an alert generated to a user when the predicted future level of the at least one of the one or more products is less than the specified threshold level

7. The computer-implemented method of claim 1, wherein:
the dynamically produced output is associated with an automated replenishment order for at least one of the one or more products.

8. The computer-implemented method of claim 7, further comprising:
dynamically recalculating a replenishment schedule for the at least one of the one or more products with respect to each of the plurality of industrial plants.

9. The computer-implemented method of claim 1, further comprising:
determining future ambient temperature data for at least a portion of the industrial plant; and
inferring data to virtually populate the at least one level of the hierarchical data structure for the another one or more of the plurality of data streams, based on the collected real-time data for one or more data streams having a defined derivative relationship therewith, and further based on the determined future ambient temperature data.

10. The computer-implemented method of claim 1, wherein the respective process elements comprise one or more of: a unit operation; an asset; and a process stream.

11. A system comprising:
at least one central computing device in functional association with a data storage network and a communications network, and configured for bilateral data communication with each of a plurality of industrial plants via the communications network, and one or more distributed user computing devices respectively configured to generate a user interface on a display unit thereof,
wherein the at least one central computing device is configured to direct the performance of operations comprising, for each of the plurality of industrial plants:
mapping each of a plurality of data streams in an industrial plant to a common hierarchical data structure, wherein the data streams correspond to respective values or states generated in association with each of one or more process elements, and wherein the mapped data streams define hierarchical process relationships between subsets of the respective process elements;
determining one or more of the plurality of process elements as correlating to consumption for each of the one or more products supplied to the industrial plant;
collecting real-time data to populate at least one level of the hierarchical data structure for one or more of the plurality of data streams;
inferring data to virtually populate the at least one level of the hierarchical data structure for another one or more of the plurality of data streams, based on the collected real-time data for one or more data streams having a defined derivative relationship therewith; and
dynamically producing an output corresponding to a replenishment schedule for the each of the one or more products supplied to the industrial plant based on the collected real-time data and the inferred data corresponding to real-time values or states for each respectively correlated process element.

12. The system of claim 11, wherein:
the mapped data streams defining hierarchical process relationships between subsets of the respective one or more process elements are dynamically generated based on input from a graphical user interface generated on a display unit.

13. The system of claim 12, wherein:
the graphical user interface comprises visual elements corresponding to respective process elements, and tools enabling the selective arranging of the visual elements corresponding to their respective interactions there between, and
one or more of the defined hierarchical process relationships are determined based on a spatial and/or temporal process flow between selectively arranged visual elements.

14. The system of claim 13, wherein:
the graphical user interface further enables data entry for one or more states and/or values associated with one or more of the selectively arranged visual elements, and
one or more of the process elements for which data entry is available, and/or data limits or ranges for one or more of the process elements for which data entry is available, are dynamically determined based on the established relationships between the corresponding visual elements and others of the selectively arranged visual elements.

15. The system of claim 11, wherein:
the dynamically produced output is an alert generated to a user when a determined level of at least one of the one or more products is less than a specified threshold level.

16. The system of claim 11, wherein the at least one central computing device is further configured to:
predict a future level for at least one of the one or more products as being less than a specified threshold level, wherein the predicted future level is based on the collected real-time data for at least one data stream, and at least one other data stream having a defined hierarchical process relationship therewith and further corresponding to a process element correlated with the at least one of the one or more products; and
the dynamically produced output is an alert generated to a user when the predicted future level of the at least one of the one or more products is less than the specified threshold level.

17. A system for optimizing the supply of one or more chemical products to a plurality of industrial plants, the system comprising:
means for directly monitoring real-time values or states for one or more of a plurality of process elements correlating to consumption for each of the one or more products supplied to the industrial plant;
means for generating data corresponding to virtual values or states for each of any remaining one or more process elements, based on established hierarchical data relationships between certain ones of the plurality of process elements; and
means for dynamically producing an output corresponding to a replenishment schedule for the each of the one or more products supplied to the industrial plant, based on the directly monitored data and the generated data.

18. The system of claim 17, further comprising means for dynamically recalculating a replenishment schedule for the at least one of the one or more products with respect to each of the plurality of industrial plants.

19. The system of claim 17, wherein:
the dynamically produced output is an alert generated to a user when a determined level and/or a predicted future level of at least one of the one or more products is less than a specified threshold level.

20. The system of claim 17, wherein:
the dynamically produced output is associated with an automated replenishment order for at least one of the one or more products.
